(19) United States
(12) Patent Application Publication
(10) Pub. No.: US 2011/0154680 A1
(43) Pub. Date: Jun. 30, 2011

(54) DRYER HAVING CIRCULATION APPARATUS AND CONTROL METHOD THEREOF

(75) Inventor: Ju Dong Lee, Incheon (KR)

(73) Assignee: Daewoo Electronics Corporation, Seoul (KR)

(21) Appl. No.: 12/649,416

(22) Filed: Dec. 30, 2009

(51) Int. Cl. F26B 11/02; G05B 15/00

(52) U.S. Cl. 34/132; 700/275

(57) ABSTRACT

A dryer is disclosed. The dryer includes a circulation duct connecting an intake duct supplying heated air into a drum receiving laundry to an exhaust duct guiding the air discharged from the drum to an outside of the dryer; a door provided to the circulation duct to open or close the circulation duct; and a drive unit enabling an opening or closing operation of the door.

### BACKGROUND OF THE INVENTION

1. Field of the Invention

The present invention relates to a dryer and, more particularly, to a dryer including a circulation apparatus, which can reduce an operation time of low efficiency at an initial stage of a drying operation, and a control method thereof.

2. Description of the Related Art

FIG. 1 is a schematic diagram showing a flow path of a conventional dryer and FIG. 2 is a partially cut-away perspective view of the conventional dryer.

Referring to FIGS. 1 and 2, the conventional dryer includes a cabinet 2 which forms an external appearance of the dryer and is provided with an opening formed in front thereof and through which laundry to be dried is put into the dryer, a drum 12 which is rotatably mounted inside the cabinet 2 to accommodate the laundry to be dried and has opened front and rear portions for allowing air to pass therethrough, a heater 18 which is disposed inside the cabinet 2 to heat the air sucked into the cabinet 2, an intake duct 20 which guides the heated air passed through the heater 18 to the rear of the drum 12, an exhaust unit 22 which exhausts the air hydrated by drying the laundry to the outside of the cabinet 2, a blower fan (not shown) which is installed in the exhaust unit 22, and a motor (not shown) and a belt 40 which drive the drum 12 and the blower fan. A lifter 11 is mounted on an inner peripheral surface of the drum 12 to lift up and drop the laundry to be dried.

The exhaust unit 22 includes a lint duct 25 which filters foreign substances from the air passing therethrough by a filter 24 mounted therein, a fan housing 26 which communicates with the lint duct 25 and houses the blower fan and an exhaust duct 27 which communicates with the fan housing 26 at one end thereof and extends to the outside of the cabinet 2 at the other end.

Operation of the conventional dryer having the above described structure will be described.

First, by operating the dryer after putting the laundry to be dried into the drum 12 and closing a door, the motor is driven to rotate the drum 12 and the blower fan and the heater 18 are operated together.

At this time, as the drum 12 is rotated, the laundry to be dried in the drum 12 is lifted up and dropped by the lifter 11. External air is sucked into the heater 18, heated to a high temperature and low humidity and then supplied to the inside of the drum 12 through the intake duct 20.

The air with high temperature and low humidity supplied to the inside of the drum 12 is brought into direct contact with the laundry to dry the laundry and changed to air with low temperature and high humidity. While drying the laundry, the air is moved toward the front of the drum 12 and is then exhausted to the outside of the dryer through the exhaust unit 22.

In the conventional dryer, at an initial stage of a drying operation, air supplied into the drum is exhausted outside after performing the drying operation with low efficiency, thereby making it difficult to reduce time and costs for the drying operation.

Further, when the dryer includes a steam generator, steam supplied to the laundry is exhausted from the cabinet without a separate circulation process, thereby making it difficult to reduce time for supplying moisture to the laundry using the steam.

Therefore, there is a need to solve such problems of the conventional dryer.

### SUMMARY OF THE INVENTION

Embodiments of the present invention include a dryer that includes a circulation apparatus to reduce an operation time of low efficiency at an initial stage of a drying operation and to reduce a steam supply time, and a control method thereof.

In accordance with one aspect of the invention, a dryer including a circulation apparatus includes: a circulation duct connecting an intake duct supplying heated air into a drum receiving laundry to an exhaust duct guiding the air discharged from the drum to an outside of the dryer; a door provided to the circulation duct to open or close the circulation duct; and a drive unit enabling an opening or closing operation of the door.

The door may open and close the exhaust duct.

When the door opens the circulation duct, the door may close the exhaust duct.

When the door opens the circulation duct, the door may open the exhaust duct.

The door may be disposed at a portion where the exhaust duct is connected to the circulation duct.

The drive unit may include a step motor moving a wire coupled to one end of the door, and an elastic member interposed between the other end of the door and the circulation duct to provide restoration force to the door.

The step motor and the elastic member may be located on an outer periphery of the circulation duct.

In accordance with another aspect of the invention, a control method of a dryer including a circulation apparatus includes: performing a circulation operation of opening a circulation duct and closing an exhaust duct when a drying operation is started; performing a determination operation to determine whether a preset time has elapsed; and performing a driving operation of closing the circulation duct and opening the exhaust duct if the preset time has elapsed.

In the circulation operation, opening of the circulation duct and closing of the exhaust duct may be sequentially performed by a door disposed at a portion where the exhaust duct is connected to the circulation duct.

In the driving operation, opening of the exhaust duct and closing of the circulation duct may be sequentially performed by the door.

The circulation duct may be maintained in an open state and the exhaust duct may be maintained in a closed state if the preset time has not elapsed.

### BRIEF DESCRIPTION OF THE DRAWINGS

The above and other aspects, features and advantages of the present invention will become apparent from the following detailed description in conjunction with the accompanying drawings, in which:

FIG. 1 is a schematic diagram showing a flow path of a conventional dryer;

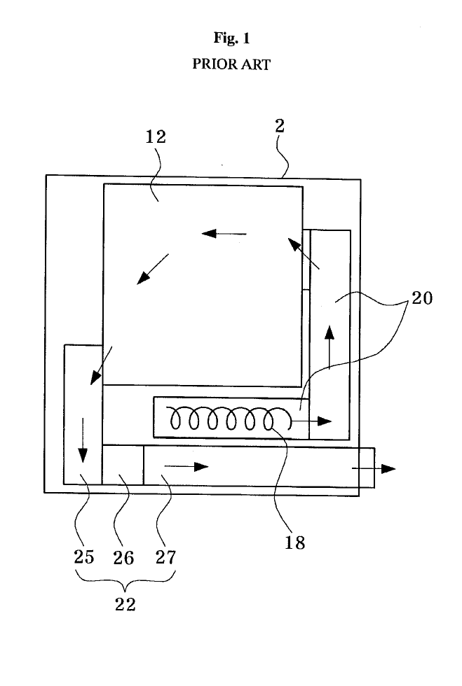

FIG. 2 is a partially cut-away perspective view of the conventional dryer.

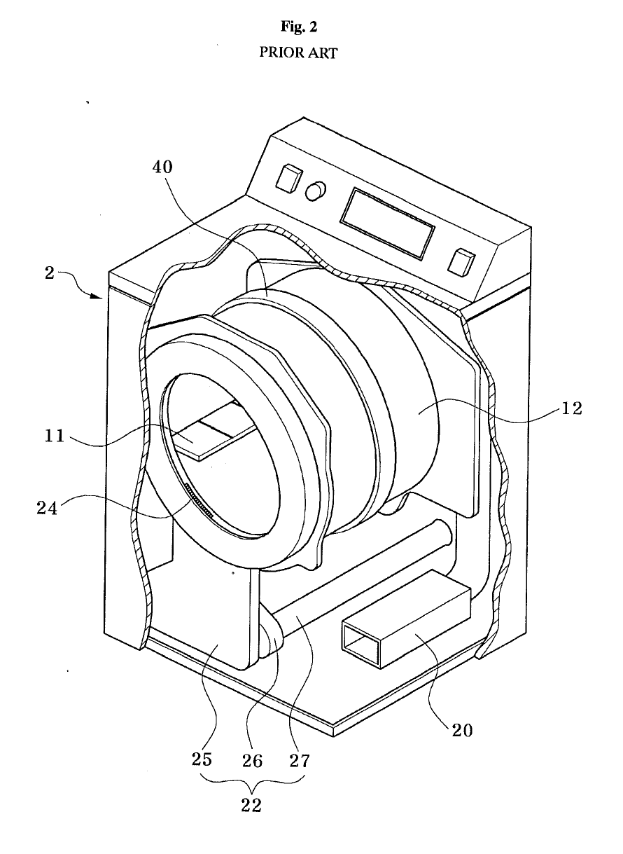

FIG. 3 is a structural view of a dryer having a circulation apparatus in accordance with an embodiment of the present invention;

FIG. 4 is an exploded perspective view of a gas heater of the dryer in accordance with an embodiment of the present invention;

FIG. 5 is an exploded perspective view illustrating a circulation duct of a circulation apparatus in accordance with an embodiment of the present invention;

FIG. 6 is a sectional view of the circulation apparatus in accordance with the embodiment of the present invention;

FIG. 7 is a sectional view of the circulation apparatus in an operated state in accordance with the embodiment of the present invention;

FIG. 8 is a plan view of an intake flow path of the dryer in accordance with an embodiment of the present invention;

FIG. 9 is a side sectional view of a circulation flow path of the dryer in accordance with an embodiment of the present invention;

FIG. 10 is a plan view of an exhaust flow path of the dryer in accordance with an embodiment of the present invention; and

FIG. 11 is a flowchart of a control method of a dryer including a circulation apparatus in accordance with an embodiment of the present invention.

### DETAILED DESCRIPTION OF THE INVENTION

Embodiments of the invention will now be described with reference to the accompanying drawings. For convenience of description, a dryer provided with a valve for a gas heater will be described by way of example. It should be noted that the drawings are not to precise scale and may be exaggerated in thickness of lines or size of components for the purpose of convenience and clarity only. Furthermore, terms used herein are defined in consideration of functions in the present invention and can be changed according to the custom or intention of users or operators. Thus, definition of such terms should be determined according to overall disclosures set forth herein.

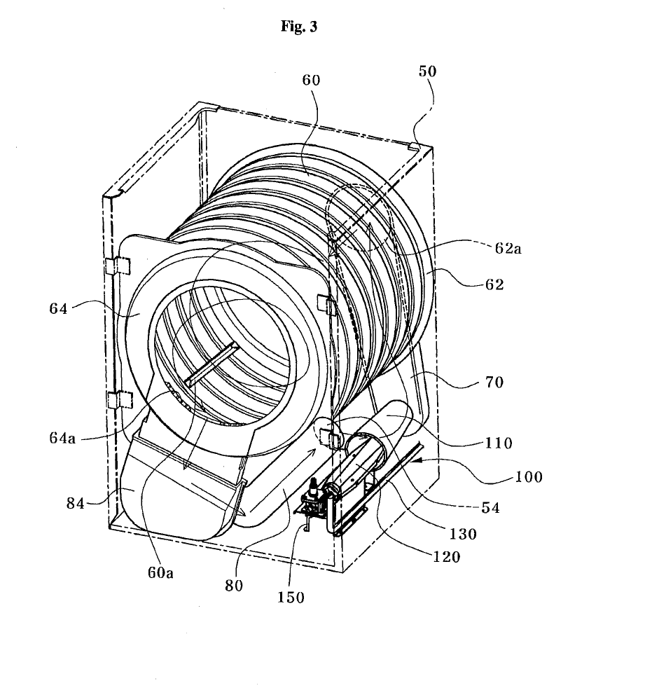

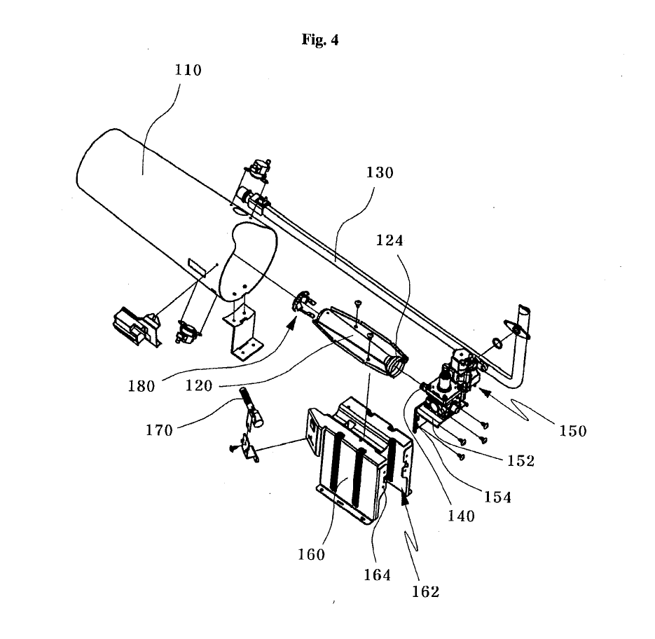

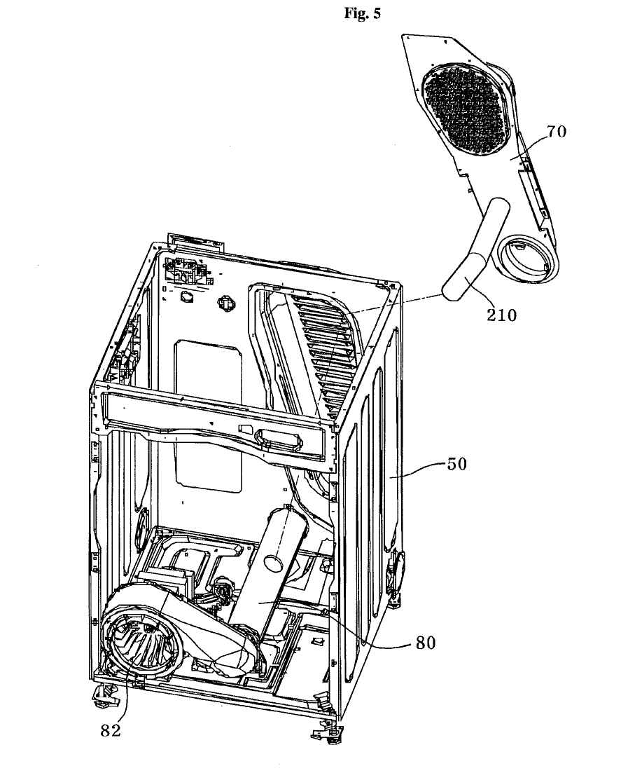

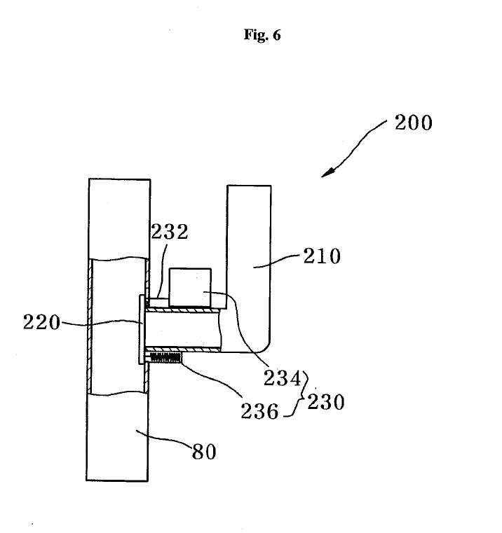

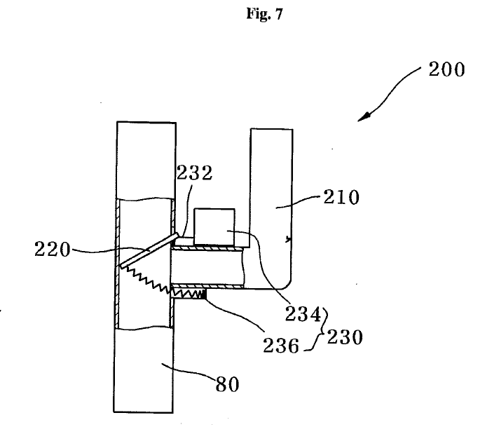

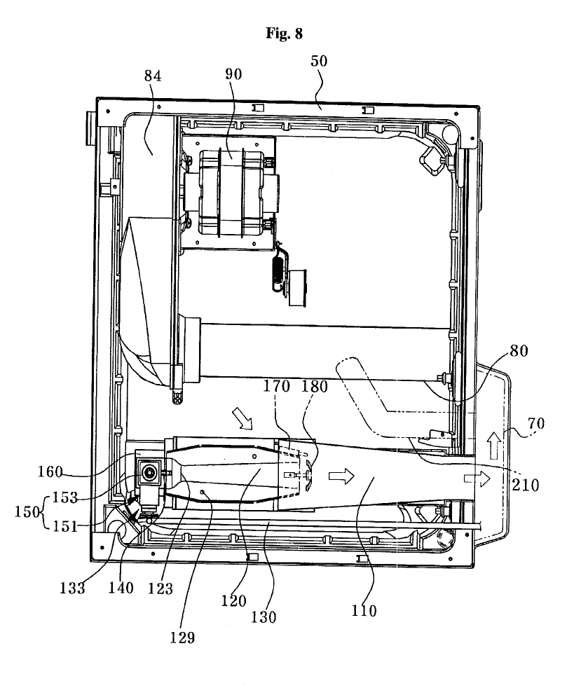

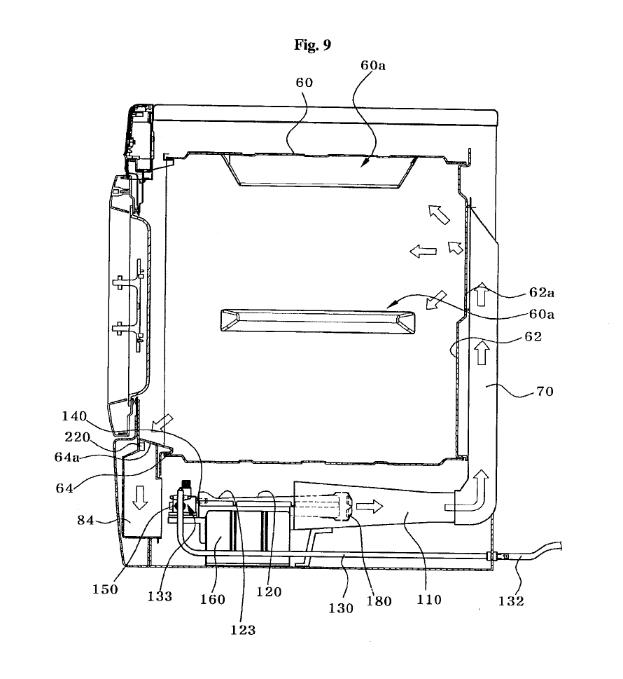

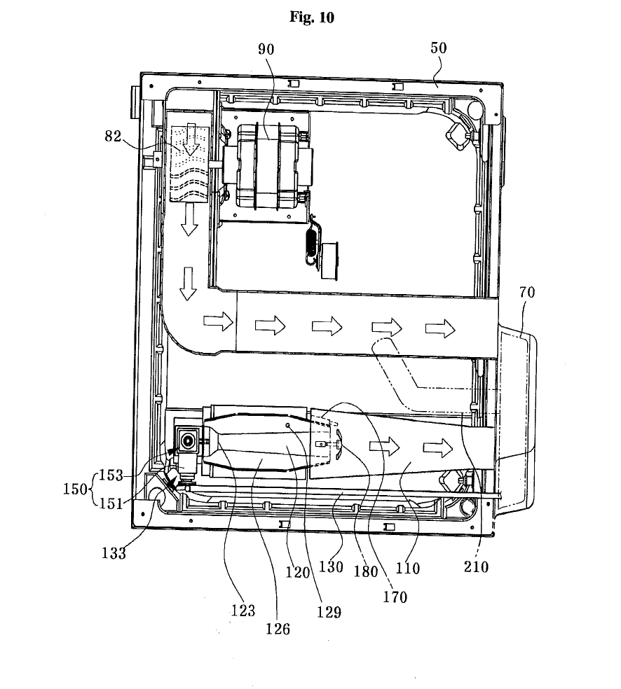

FIG. 3 is a structural view of a dryer having a circulation apparatus in accordance with an embodiment of the invention, FIG. 4 is an exploded perspective view of a gas heater of the dryer in accordance with an embodiment of the invention, FIG. 5 is an exploded perspective view illustrating a circulation duct of a circulation apparatus in accordance with an embodiment of the invention, FIG. 6 is a sectional view of the circulation apparatus in accordance with the embodiment of the invention, FIG. 7 is a sectional view of the circulation apparatus in an operated state in accordance with the embodiment of the invention, FIG. 8 is a plan view of an intake flow path of the dryer in accordance with an embodiment of the invention, FIG. 9 is a side sectional view of a circulation flow path of the dryer in accordance with an embodiment of the invention, and FIG. 10 is a plan view of an exhaust flow path of the dryer in accordance with an embodiment of the invention.

Referring to FIGS. 3 to 10, a dryer in accordance with an embodiment of the invention includes a cabinet 50 which has a predetermined space therein and is provided with an opening and discharge port 54, a drum 60 which rotatably mounted inside of the cabinet 50 to accommodate the laundry to be dried, a lifter 60a which is mounted on an inner wall of the drum 60 to lift up the laundry to be dried, an intake duct 70 which guides air inside the cabinet 50 to the inside of the drum 60, a gas heater 100 installed in the intake duct 70, an exhaust fan 82 (refer to FIG. 10) which is provided between the drum 60 and the discharge port 54, an exhaust duct 80 which is provided between the exhaust fan 82 and the discharge port 54 and a driving motor 90 (refer to FIG. 10) which is connected with a rotation shaft of the exhaust fan 82.

When power is applied to the driving motor 90, the exhaust fan 82 is rotated to circulate air and the air flowing inside of the cabinet 50 is changed into high temperature air while passing the gas heater 100.

The air is supplied to the inside of the drum 60 along the intake duct 70 and is brought into contact with the laundry to perform a drying operation or a sterilizing operation.

After that, the air exhausted by the exhaust fan 82 flows along the exhaust duct 80 and is exhausted to an outside through the discharge port 54 of the cabinet 50, thereby completing the circulation of the air.

The drum 60 is formed in a cylindrical shape with an opened front portion, which corresponds to the opening, and a rear portion, and is rotatably mounted to a support panel 62 which is formed with a through hole part 62a.

The support panel 62 is mounted at a rear side of the cabinet 50 to rotatably support the drum 60. Also, the through hole part 62a of the support panel 62 is communicated with the intake duct 70.

A front panel 64 is installed between the front end portion of the drum 60 and the opening of the cabinet 50 and is formed with an exhaust hole 64a at a lower end portion thereof.

The exhaust hole 64a is connected with a connection duct 84 which is extended toward the exhaust fan 82, and a housing (not shown) for housing the exhaust fan 82 therein is placed between the connection duct 84 and the exhaust duct 80.

The intake duct 70 is extended from the gas heater 100 to the through hole part 62a. Therefore, the air is changed to air having a temperature higher than a predetermined temperature while passing through the gas heater 100 and flows along the intake duct 70 to be supplied to the inside of the drum 60 through the through hole part 62a.

At this time, since a contact area between the high temperature air and the laundry to be dried is increased as the drum 60 connected with the driving motor 90 by a belt (not shown), the efficiency of the drying and sterilizing operation is enhanced.

The gas heater 100 includes a gas pipe 130 for supplying gas, a valve 150 for controlling supply and cutoff of gas and an amount of the supplied gas, a nozzle 140 provided at a side of the valve 150, a mixing pipe 120 placed corresponding to the nozzle 140 to mix the gas and the air, an ignition plug 170 mounted on the mixing pipe 120 to generate sparks, a guide duct 110 placed at an outside of the mixing pipe 120 to guide the heated air, a bracket 160 for mounting the mixing pipe 120 to the cabinet 50, and a flame holder 180 placed in the mixing pipe 120 to prevent a flame produced by the ignition plug 170 from exceeding a predetermined size.

As the valve 150 is opened, the gas is supplied to the mixing pipe 120 along the gas pipe 130. Then, the gas is mixed with the air in the cabinet 50 and injected to the outside of the mixing pipe 120 and the flame is produced by the sparks generated in the ignition plug 170.

Size and production position of the flame are controlled by the flame holder 180, so that the flame is placed inside the guide duct 110. The air flowing in the guide duct 110 is changed into hot air with a high temperature while passing through the flame.

The bracket 160 has a grove part 160a which is formed at an upper face thereof and in which the mixing pipe 120 is seated, and a fixing face 160b which is formed at a rear side (left side in FIG. 4) and on which the ignition plug 170 is mounted.

The valve 150 is mounted on the bracket 160 by a fixing piece 152 and the fastening part 162 is provided at a front side (right side in FIG. 4) of the bracket 160 to be coupled to the fixing piece 152.

Upon installation or replacement of the valve 150, assembling of the valve 150 is completed by fixing the valve 150 to the fixing piece 152 and coupling the fixing piece 152 to the fastening part 162 formed at the front side of the bracket 160.

The fixing piece 152 is a bent panel having a ‘┐’ shape and has an upper face on which the valve 150 is mounted and a side face which comes in close contact with the fastening part 162 and is formed with through hole parts 154.

As a fastening member passes through the through hole part 154 to be fastened to the fastening hole part 164 of the fastening part 162, the valve 150 is mounted on the bracket 160 through the fixing piece 152.

At this time, the valve 150 coupled to the bracket 160 by the fixing piece 152 can be approached from the front side of the dryer through a gap between the front panel 64 and lower face of the cabinet 50.

Therefore, upon control, repair or replacement of the valve 150, it is possible to perform the operation using the gap and thus to omit the operation of separating the front panel 64 from the cabinet 50 as has been conventionally done.

The mixing pipe 120 is provided with a mixing part 124. Since the mixing part 124 includes an opening which is larger than the nozzle 140, the gas injected from the nozzle 140 and air flowing thereinto are mixed with each other in the mixing part 124.

The mixing part 124 is formed in such a manner that an end of the mixing part 120 is extended and has a hollow cylindrical shape with an opening formed at the end thereof corresponding to the nozzle 140.

The dryer further includes a circulation apparatus 200. The circulation apparatus 200 includes a circulation duct 210 connecting the intake duct 70 to the exhaust duct 80, a door 220 provided to the circulation duct 210 to open or close the circulation duct 210, a drive unit 230 enabling an opening or closing operation of the door 220, and a controller (not shown) determining operation of the drive unit 230.

When the dryer starts to operate, the controller sends an operation signal to the drive unit 230 to open the circulation duct 210 by opening the door 220.

The door 220 is provided to a portion where the exhaust duct 80 is connected to the circulation duct 210. When the door 220 opens the circulation duct 210, the exhaust duct 80 is closed by the door 220.

In other words, since the door 220 closes the exhaust duct 80 while opening the circulation duct 210, air used for a drying operation and then exhausted along the exhaust duct 80 is supplied again to the intake duct 70 along the circulation duct 210. As a result, circulation of the air can be achieved.

With this operation, the dryer has improved operation efficiency by circulation of air even when the air does not sufficiently absorb moisture from laundry due to low efficiency operation at an initial stage of the drying operation.

The drive unit 230 includes a step motor 234 configured to pull a wire 232 coupled to one end of the door 220, and an elastic member 236 interposed between the other end of the door 220 and the circulation duct 210 to provide restoration force to the door 220. The step motor 234 and the elastic member 236 are located on an outer periphery of the circulation duct 210 to prevent damage by hot air.

When a circulation operation is started, the step motor 234 is driven and pulls the wire 232 to open the door 220 in response to a signal from the controller. When the circulation operation is finished, the driving force of the step motor 234 is released so that the door 220 closes the circulation duct 210 by restoration force of the elastic member 236. At this time, the exhaust duct 80 is open by the door 220 and air discharged by the exhaust fan 82 is exhausted outside through the discharge port 54 of the cabinet 50 along the exhaust duct 80.

Next, operation of the dryer including the circulation apparatus in accordance with an embodiment of the invention will be described.

When a user manipulates an operation button (not shown), the power is applied to the driving motor 90 to rotate the exhaust fan 82 and the drum 60.

By the driving of the exhaust fan 82, the air flowing inside of the cabinet 50 is moved to an upper side of the cabinet 50 along the intake duct 70 vertically formed on a rear face of the cabinet 50.

When the valve 150 is opened, gas supply along the gas pipe 130 is initiated and the supplied gas passes through the nozzle 140 to be injected to the inside of the mixing pipe 120.

The gas is primarily mixed with the air flowed in through the nozzle 140 and is secondarily mixed with the air flowing in through the space between the mixing pipe 120 and the nozzle 140.

The mixture of the air and gas is injected through the mixing pipe 120 and a flame is produced by operation of the ignition plug 170.

At this time, since the injected mixture collides with the flame to form a vortex, the flame is laterally spread in the vicinity of the flame holder 180.

The air flowing the inside of the intake duct 70 along the guide duct 110 is heated into dry air with a temperature higher than a predetermined temperature.

After that, the air flowing in the inside of the drum 60 through the through hole part 62a is swirled to dry the laundry.

The front panel 64 is placed between the front end portion of the drum 60 and the opening of the cabinet 50 and is formed with an exhaust hole 64a, and the air which finished the dry operation is exhausted to the outside of the drum 60 through the exhaust hole 64a.

After that, the air flows to the exhaust fan 82 through the connection duct 84 communicated with the exhaust hole 64a, then moves from the exhaust fan 82 along the exhaust duct 80 and is exhausted to the outside of the cabinet 50 through the discharge port 54.

At an initial stage of the drying operation, air is circulated again to the intake duct 70 instead of being directly exhausted outside the dryer. Such a circulation operation of the dryer will be described hereinafter.

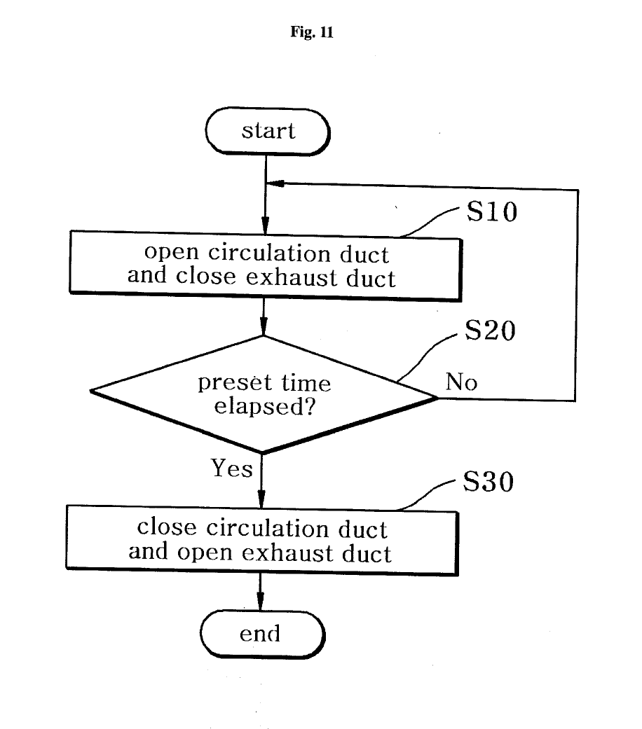

FIG. 11 is a flowchart of a control method of the dryer including the circulation apparatus in accordance with an embodiment of the present invention. Referring to FIGS. 3 to 11, the control method of the dryer according to the embodiment includes a circulation operation S10 of opening the circulation duct 210 while closing the exhaust duct 80 when drying operation is started; a determination operation S20 of determining whether a preset time has elapsed; and a driving operation in S30 of closing the circulation duct 210 while opening the exhaust duct 80 if the preset time has elapsed.

At an initial stage of the drying operation, opening of the circulation duct 210 and closing of the exhaust duct 80 are sequentially performed by the door 220 which is rotated by the drive unit 230. As a result, air discharged from the drum 60 is circulated to the intake duct 70 along the circulation duct 210.

If a preset time elapses after the circulation operation, the controller detects the preset time and releases the step motor 234. As a result, the door 220 is rotated to an original position by restoration force of the elastic member 236 to thereby close the circulation duct 210. Here, since the exhaust duct 80 is open, the air discharged from the drum 60 is exhausted outside the cabinet 50 through the exhaust duct 80.

It should be understood that if the preset time has not elapsed in the determination operation in S20, the circulation operation in S10 is maintained to continue circulation of the air until drying operation of high efficiency is performed.

As such, the embodiments of the invention provide the dryer including the circulation apparatus, which can reduce an operation time of low efficiency at an initial stage of the drying operation, and the control method thereof.

According to the embodiments, the dryer includes the circulation duct which allows air exhausted through the exhaust duct to be circulated again to the intake duct at an initial drying operation of low efficiency so as to reduce a drying operation time of low efficiency, thereby reducing time and costs for a drying operation.

Further, according to the embodiments, the dryer allows steam passing through the drum to be circulated again to the drum instead of being exhausted outside during a steam supply operation, thereby reducing time and costs for a steam supply operation through reduction of time for steam supply.

Although the present invention has been described with reference to the embodiments shown in the drawings, it should be understood that these embodiments are provided for illustrative purpose and that various equivalent modifications and alterations will be apparent to those skilled in the art without departing from the scope and spirit of this invention. In addition, although the present invention has been described with reference to the dryer as specifically described herein, it should be noted that the dryer has been illustrated by way of example, and that the dryer including the circulation apparatus of the invention may be applied to other products, without being limited to the dryer. Therefore, the scope and spirit of the invention is limited only by the claims set forth herein as follows.

What is claimed is:

1. A dryer including a circulation apparatus, comprising:
a circulation duct connecting an intake duct supplying heated air into a drum receiving laundry to an exhaust duct guiding the air discharged from the drum to an outside of the dryer;
a door provided to the circulation duct to open or close the circulation duct; and
a drive unit enabling an opening or closing operation of the door.

2. The dryer of claim 1, wherein the door opens or closes the exhaust duct.

3. The dryer of claim 2, wherein, when the door opens the circulation duct, the door closes the exhaust duct.

4. The dryer of claim 2, wherein when the door closes the circulation duct, the door opens the exhaust duct.

5. The dryer of claim 2, wherein the door is disposed at a portion where the exhaust duct is connected to the circulation duct.

6. The dryer of claim 2, wherein the drive unit comprises a step motor moving a wire coupled to one end of the door, and an elastic member interposed between the other end of the door and the circulation duct to provide restoration force to the door.

7. The dryer of claim 6, wherein the step motor and the elastic member are located on an outer periphery of the circulation duct.

8. A control method of a dryer including a circulation apparatus, comprising:
performing a circulation operation of opening a circulation duct and closing an exhaust duct when a drying operation is started;
performing a determination operation to determine whether a preset time has elapsed; and
performing a driving operation of closing the circulation duct and opening the exhaust duct if the preset time has elapsed.

9. The control method of claim 8, wherein, in the circulation operation, opening of the circulation duct and closing of the exhaust duct are sequentially performed by a door disposed at a portion where the exhaust duct is connected to the circulation duct.

10. The control method of claim 9, wherein, in the driving operation, opening of the exhaust duct and closing of the circulation duct are sequentially performed by the door.

11. The control method of claim 8, wherein the circulation duct is maintained in an open state and the exhaust duct is maintained in a closed state if the preset time has not elapsed.
